(19) United States
(12) Patent Application Publication
(10) Pub. No.: US 2009/0323814 A1
(43) Pub. Date: Dec. 31, 2009

(54) TRACKING POINT DETECTION APPARATUS AND METHOD, PROGRAM, AND RECORDING MEDIUM

(75) Inventors: Naoki Takeda, Tokyo (JP); Tetsujiro Kondo, Tokyo (JP); Kenji Takahashi, Kanagawa (JP); Tomoyuki Otsuki, Kanagawa (JP); Takamasa Yamano, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Sony Corporation, Tokyo (JP)

(21) Appl. No.: 12/491,686

(22) Filed: Jun. 25, 2009

(30) Foreign Application Priority Data
Jun. 26, 2008 (JP) 2008-167296

(51) Int. Cl. H04N 7/26

(52) U.S. Cl. 375/240.16; 375/E07.124

(57) ABSTRACT

A tracking-point detection apparatus includes a background motion vector detection unit, a background image generation unit, a gate setting unit, a tracking-point motion detection unit, and a tracking-point determination unit. The background motion vector detection unit is configured to detect motion vectors for pixels in a frame included in a moving image and to detect, in accordance with the detected motion vectors, a background motion vector representing the motion of a background image of the moving image. The background image generation unit is configured to calculate and update a pixel value of a pixel in a background frame, which is a frame of a background image, stored in a memory by performing motion compensation on a pixel in the frame in accordance with the detected background motion vector. The gate setting unit is configured to set a gate in accordance with data of the background frame stored in the memory.

### BACKGROUND OF THE INVENTION

1. Field of the Invention

The present invention relates to a tracking point detection apparatus and method, a program, and a recording medium. More specifically, the present invention relates to a tracking point detection apparatus and method, a program, and a recording medium that are capable of tracking an object more efficiently and with more certainty.

2. Description of the Related Art

For example, a monitoring image transmitted from an image pickup device is displayed on a television (TV) monitor in a home security system. A method for improving the accuracy with which incomers are detected by using a monitoring device, which is configured by combining a microwave sensor and an image sensor has been proposed for such a system.

Moreover, a method for automatically tracking a tracking point set on a tracking target and displaying an image of the tracking target has been proposed, the tracking target being an object that shifts (moves) over images displayed as a moving image.

However, for example, if a plurality of objects move in the moving image, it is difficult to track a desired object with certainty.

Thus, a method called a gate method has been proposed. When tracking is performed by the gate method, a tracking point is detected in accordance with only pixels included in a predetermined area called a gate, the predetermined area having been previously set.

However, pixels included in the gate are not included in an image of an object that is desired to be tracked, on every occasion. For example, a gate may include pixels of an image of an object that is desired to be tracked and pixels of a background image behind the object.

In such a case, if an object is tracked in accordance with only pixels included in a gate, a wrong tracking point may be detected.

Thus, a technology has been proposed in which a motion vector for a background image of a moving image is estimated, pixels having the same motion vector as the estimated motion vector are eliminated from the pixels included in a gate, and an object is tracked (for example, see Japanese Unexamined Patent Application Publication No. 2005-303983).

### SUMMARY OF THE INVENTION

However, even using the technology disclosed in Japanese Unexamined Patent Application Publication No. 2005-303983, for example, if an object image and a background image move similarly, a wrong tracking point may be determined.

It is desirable to track an object image more efficiently and with more certainty.

A tracking-point detection apparatus according to an embodiment of the present invention is a tracking-point detection apparatus including: background motion vector detection means for detecting motion vectors for pixels in a frame from among frames constituting a moving image and detecting, in accordance with the detected motion vectors, a background motion vector representing the motion of a background image of the moving image; background image generation means for calculating and updating a pixel value of a pixel in a background frame, which is a frame of a background image, stored in a memory by performing motion compensation on a pixel in the frame in accordance with the detected background motion vector; gate setting means for setting an area in which detection of a motion vector representing the motion of a pixel existing at a tracking point specified in the frame is performed as a motion detection area constituted by a predetermined number of pixels having the pixel existing at the tracking point as the center, and setting a gate constituted by pixels, the number of which being less than or equal to the number of the pixels included in the motion detection area, by eliminating a pixel regarded as being a pixel of the background image of the moving image from the pixels included in the motion detection area in accordance with data of the background frame stored in the memory; tracking-point motion detection means for detecting a motion vector for the pixel existing at the tracking point using a pixel included in the gate; and tracking-point determination means for determining a pixel existing at a tracking point for the latest frame in accordance with the detected motion vector for the pixel existing at the tracking point for the frame.

The background-image generation means may store, in the memory, data of a frame from which processing starts as initial data of the background frame, perform motion compensation on each of pixels in a temporally previous frame that is temporally previous to the latest frame in accordance with the background motion vector, and detect a candidate for a pixel of the background image of the moving image by determining whether the absolute value of the difference between a pixel value of a pixel in the latest frame and a pixel value of a corresponding pixel in the temporally previous frame is less than or equal to a first preset threshold.

In a case where the absolute value of the difference between the pixel value of the pixel in the latest frame and the pixel value of the corresponding pixel in the temporally previous frame is determined to be less than or equal to the first preset threshold, the background-image generation means may further calculate the absolute value of the difference between the pixel value of the pixel in the latest frame and a pixel value of a corresponding pixel in the background frame, increment a count value of a counter for the corresponding pixel in the background frame if the absolute value of the difference between the pixel value of the pixel in the latest frame and the pixel value of the corresponding pixel in the background frame is determined to be less than or equal to a second preset threshold, and determine whether the pixel value of the corresponding pixel in the background frame should be updated in accordance with the count value of the counter for the corresponding pixel in the background frame.

In a case where the absolute value of the difference between the pixel value of the pixel in the latest frame and the pixel value of the corresponding pixel in the temporally previous frame is determined to be less than or equal to the first preset threshold and the absolute value of the difference between the pixel value of the pixel in the latest frame and the pixel value of the corresponding pixel in the background frame is determined to be less than or equal to the second preset threshold, the background-image generation means may determine whether the count value of the counter for the corresponding pixel in the background frame is greater than or equal to a third preset threshold, and calculate a pixel value of the corresponding pixel in the background frame by performing predetermined calculation if the count value of the counter for the corresponding pixel in the background frame is determined to be greater than or equal to the third preset threshold.

The background-image generation means may calculate a pixel value of the corresponding pixel in the background frame using the pixel value of the pixel in the latest frame, the pixel value of the corresponding pixel in the background frame, and a weighting factor determined in accordance with the count value of the counter for the corresponding pixel in the background frame.

The gate setting means may set, in the temporally previous frame, a motion detection area constituted by a predetermined number of pixels having a pixel existing at a tracking point as the center, the tracking point being specified in the temporally previous frame, read pixels in the background frame from the memory, the pixels corresponding to the motion detection area, and set the gate by eliminating a pixel regarded as being a pixel of the background image of the moving image from among the pixels included in the motion detection area, the pixel regarded as being a pixel of the background image of the moving image being a pixel in the temporally previous frame and being a pixel for which the absolute value of the difference between a pixel value of the pixel in the temporally previous frame and a pixel value of a corresponding pixel in the background frame is less than or equal to a preset threshold.

The background motion vector detection means may detect motion vectors for the pixels in the frame, each of the motion vectors being detected in accordance with the absolute value of the difference between a pixel value of a corresponding pixel in the latest frame and a pixel value of a corresponding pixel in the temporally previous frame, generate a histogram regarding the detected motion vectors, and detect a motion vector indicated by a peak in the generated histogram as the background motion vector.

A tracking-point detection method according to an embodiment of the present invention is a tracking-point detection method including the steps of: detecting motion vectors for pixels in a frame from among frames constituting a moving image and detecting, in accordance with the detected motion vectors, a background motion vector representing the motion of a background image of the moving image; calculating and updating a pixel value of a pixel in a background frame, which is a frame of a background image, stored in a memory by performing motion compensation on a pixel in the frame in accordance with the detected background motion vector; setting an area in which detection of a motion vector representing the motion of a pixel existing at a tracking point specified in the frame is performed as a motion detection area constituted by a predetermined number of pixels having the pixel existing at the tracking point as the center, and setting a gate constituted by pixels, the number of which being less than or equal to the number of the pixels included in the motion detection area, by eliminating a pixel regarded as being a pixel of the background image of the moving image from the pixels included in the motion detection area in accordance with data of the background frame stored in the memory; detecting a motion vector for the pixel existing at the tracking point using a pixel included in the gate; and determining a pixel existing at a tracking point for the latest frame in accordance with the detected motion vector for the pixel existing at the tracking point for the frame.

A program according to an embodiment of the present invention is a program for causing a computer to function as: background motion vector detection means for detecting motion vectors for pixels in a frame from among frames constituting a moving image and detecting, in accordance with the detected motion vectors, a background motion vector representing the motion of a background image of the moving image; background image generation means for calculating and updating a pixel value of a pixel in a background frame, which is a frame of a background image, stored in a memory by performing motion compensation on a pixel in the frame in accordance with the detected background motion vector; gate setting means for setting an area in which detection of a motion vector representing the motion of a pixel existing at a tracking point specified in the frame is performed as a motion detection area constituted by a predetermined number of pixels having the pixel existing at the tracking point as the center, and setting a gate constituted by pixels, the number of which being less than or equal to the number of the pixels included in the motion detection area, by eliminating a pixel regarded as being a pixel of the background image of the moving image from the pixels included in the motion detection area in accordance with data of the background frame stored in the memory; tracking-point motion detection means for detecting a motion vector for the pixel existing at the tracking point using a pixel included in the gate; and tracking-point determination means for determining a pixel existing at a tracking point for the latest frame in accordance with the detected motion vector for the pixel existing at the tracking point for the frame.

According to the embodiments of the present invention, motion vectors for pixels in a frame from among frames constituting a moving image are detected and a background motion vector representing the motion of a background image of the moving image is detected in accordance with the detected motion vectors; a pixel value of a pixel in a background frame, which is a frame of a background image, stored in a memory is calculated and updated by performing motion compensation on a pixel in the frame in accordance with the detected background motion vector; an area in which detection of a motion vector representing the motion of a pixel existing at a tracking point specified in the frame is performed is set as a motion detection area constituted by a predetermined number of pixels having the pixel existing at the tracking point as the center, and a gate constituted by pixels, the number of which being less than or equal to the number of the pixels included in the motion detection area, is set by eliminating a pixel regarded as being a pixel of the background image of the moving image from the pixels included in the motion detection area in accordance with data of the background frame stored in the memory; a motion vector for the pixel existing at the tracking point is detected using a pixel included in the gate; and a pixel existing at a tracking point for the latest frame is determined in accordance with the detected motion vector for the pixel existing at the tracking point for the frame.

According to the embodiments of the present invention, an object image can be tracked more efficiently and with more certainty.

### BRIEF DESCRIPTION OF THE DRAWINGS

FIG. 1 is a block diagram showing an example of the structure of an object tracking system according to an embodiment of the present invention;

FIG. 2 is a block diagram showing an example of the structure of a tracking unit shown in FIG. 1;

FIG. 3 is a block diagram showing an example of the structure of a background motion detection unit shown in FIG. 2;

FIG. 4 is a diagram illustrating representative-point matching processing;

FIG. 5 is a diagram illustrating an example of detection of a background motion vector;

FIG. 6 is a diagram illustrating a weighting factor;

FIG. 7 is a diagram illustrating an example of a gate according to an embodiment of the present invention;

FIG. 8 is a flowchart illustrating an example of object tracking processing according to an embodiment of the present invention;

FIG. 9 is a flowchart illustrating an example of background motion detection processing;

FIG. 10 is a flowchart illustrating an example of background-image generation processing;

FIG. 11 is a flowchart illustrating an example of background-image generation processing;

FIG. 12 is a flowchart illustrating an example of gate setting processing; and

FIG. 13 is a block diagram showing an example of the structure of a personal computer.

### DESCRIPTION OF THE PREFERRED EMBODIMENTS

In the following, embodiments of the present invention will be described with reference to the drawings.

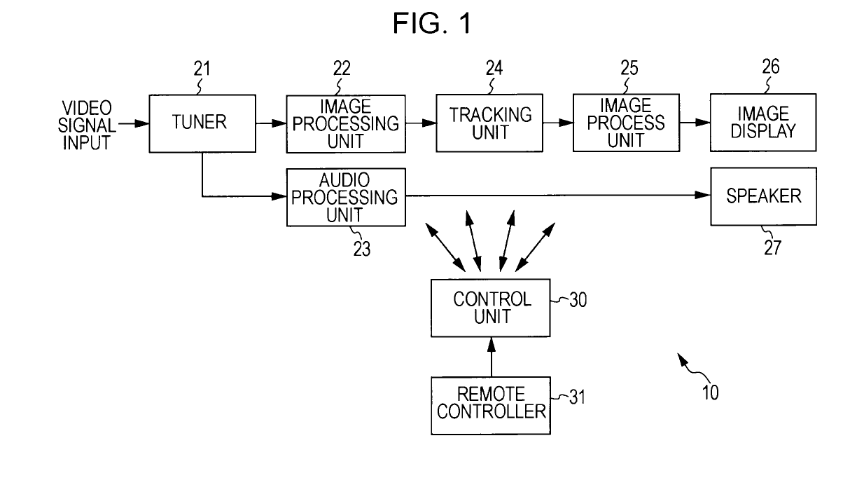

FIG. 1 is a block diagram showing an example of the structure of an object tracking system 10 according to an embodiment of the present invention.

In FIG. 1, a signal of a moving image is input to a tuner 21, and the tuner 21 divides the signal into an image signal and an audio signal. The tuner 21 outputs the image signal to an image processing unit 22, and outputs the audio signal to an audio processing unit 23.

The image processing unit 22 decodes the image signal input from the tuner 21 and supplies the resulting image to a tracking unit 24.

The tracking unit 24 executes processing for tracking a tracking point set on an object image and specified by a user in an image supplied from the image processing unit 22. The tracking unit 24 calculates a presentation position, which is used as a reference for presentation of a tracked object image, using a tracking result and the like, and outputs coordinate information regarding the presentation position to an image process unit 25.

The image process unit 25 performs processing for generating, for example, a zoomed image in accordance with the coordinate information supplied from the tracking unit 24, and the like.

An image display 26 displays, for example, a zoomed image supplied from the image process unit 25.

The audio processing unit 23 decodes the audio signal input from the tuner 21 and supplies the resulting audio signal to a speaker 27.

A control unit 30 includes, for example, a microcomputer and the like, and controls various units in accordance with instructions from a user. A remote controller 31 is operated by a user and outputs a signal corresponding to the operation to the control unit 30.

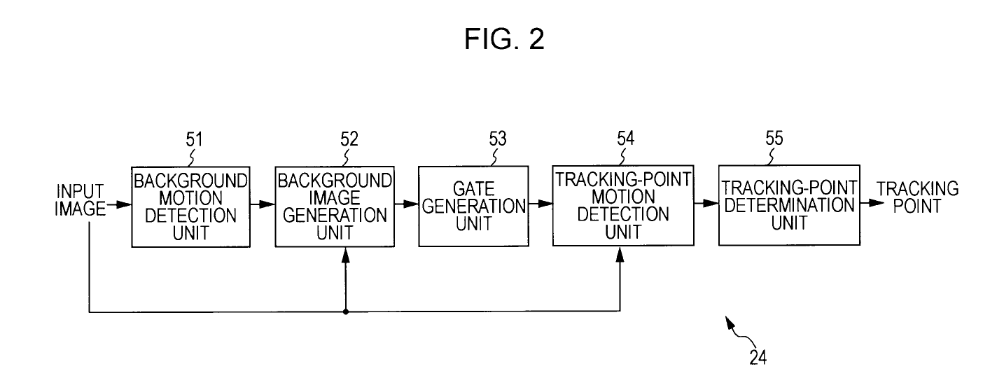

FIG. 2 is a block diagram showing an example of the structure of the tracking unit 24.

As shown in FIG. 2, the tracking unit 24 includes a background motion detection unit 51, a background image generation unit 52, a gate generation unit 53, a tracking-point motion detection unit 54, and a tracking-point determination unit 55.

The background motion detection unit 51 detects, for example, motion vectors for a predetermined pixel of a supplied image, and detects a background motion vector in accordance with detected motion vectors, the background motion vector representing the motion of a background image.

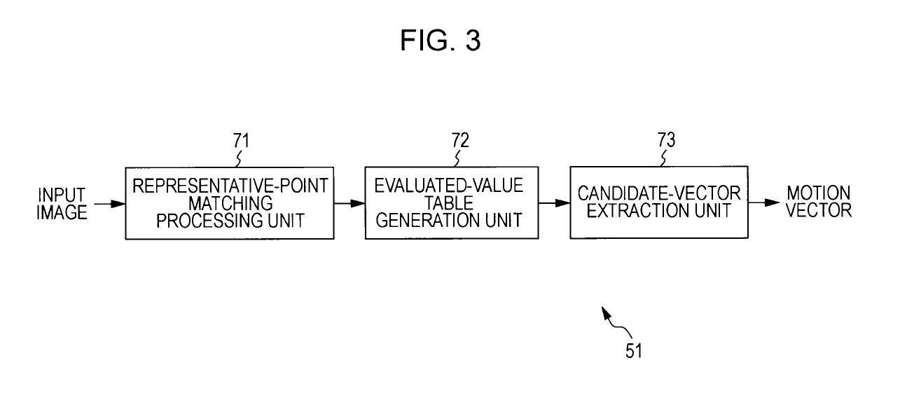

FIG. 3 is a block diagram showing a detailed example of the structure of the background motion detection unit 51. In FIG. 3, a representative-point matching processing unit 71 detects a motion vector by what is called a representative-point matching method.

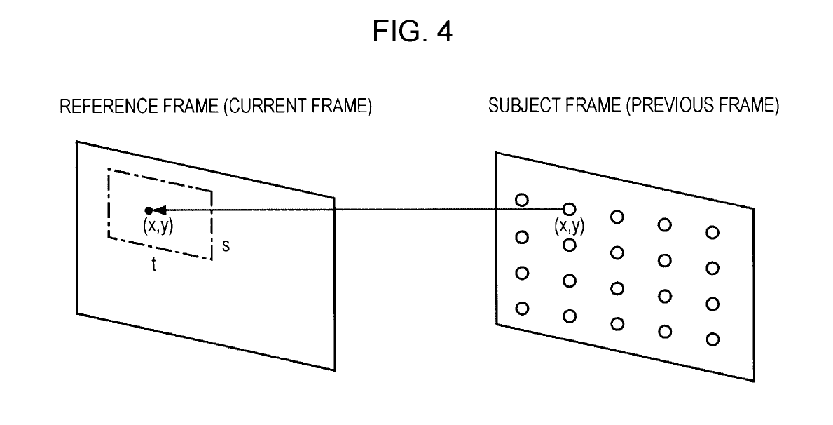

Detection of a motion vector by a representative-point matching method will be described with reference to FIG. 4. The representative-point matching processing unit 71 sets, for example, a predetermined representative point in a subject frame. In the example shown in FIG. 4, circles represent pixels to serve as representative points in the subject frame, and 20 (=5×4) pixels are to serve as representative points.

The representative-point matching processing unit 71 calculates the difference between a pixel value of a pixel serving as a predetermined representative point in the subject frame and a pixel value of a pixel included in a search area in a reference frame. In this example, a search area constituted by s×t pixels with the coordinates (x, y) as the center has been set in the reference frame, the coordinates (x, y) representing the position of a pixel serving as a representative point. The representative-point matching processing unit 71 calculates the differences between pixel values of pixels in the search area of the reference frame and a pixel value of a pixel serving as a predetermined representative point in the subject frame, the search area having the size of s×t and the coordinates (x, y) of the reference frame as the center.

Here, the subject frame in FIG. 4 is a frame that is temporally previous to the reference frame.

Then, the representative-point matching processing unit 71 stores the absolute value of each of the calculated differences between pixel values as described above in relation to a corresponding motion vector. For example, the absolute value of the difference between a pixel value of the pixel existing at the coordinates (x+1, y+1) in the reference frame and a pixel value of a pixel serving as a representative point in the subject frame is stored in relation to a motion vector (1, 1). The absolute value of the difference between a pixel value of the pixel existing at the coordinates (x−1, y−1) in the reference frame and the pixel value of the pixel serving as the representative point in the subject frame is stored in relation to a motion vector (−1, −1). The absolute value of the difference between a pixel value of the pixel existing at the coordinates (x, y) in the reference frame and the pixel value of the pixel serving as the representative point in the subject frame is stored in relation to a motion vector (0, 0).

As described above, the search area is constituted by s×t pixels, and thus the absolute values of differences for (s×t) motion vectors are calculated for each representative point.

The representative-point matching processing unit 71 performs processing for calculating the absolute values of differences and stores them in relation to corresponding motion vectors, for each of the 20 representative pixels in the subject frame. Here, the smaller (the closer to zero) the absolute value of a calculated difference, the higher the reliability of a corresponding motion vector.

Referring back to FIG. 3, an evaluated-value table generation unit 72 generates an evaluated-value table for motion vectors in accordance with a processing result from the representative-point matching processing unit 71. The evaluated-value table generation unit 72 compares, for example, the absolute value of each of the differences calculated by the representative-point matching processing unit 71 with a preset threshold. If the absolute value of the difference is less than or equal to the preset threshold, the evaluated-value table generation unit 72 increments, by one, the evaluated value of the motion vector related to the absolute value of the difference. The evaluated-value table generation unit 72 generates an evaluated-value table for motion vectors by performing such processing on all the absolute values of the differences calculated by the representative-point matching processing unit 71. Thus, an evaluated-value table is generated that includes evaluated values of the (s×t) motion vectors, each of which corresponds to a corresponding one of the pixels included in the s×t search area of the reference frame.

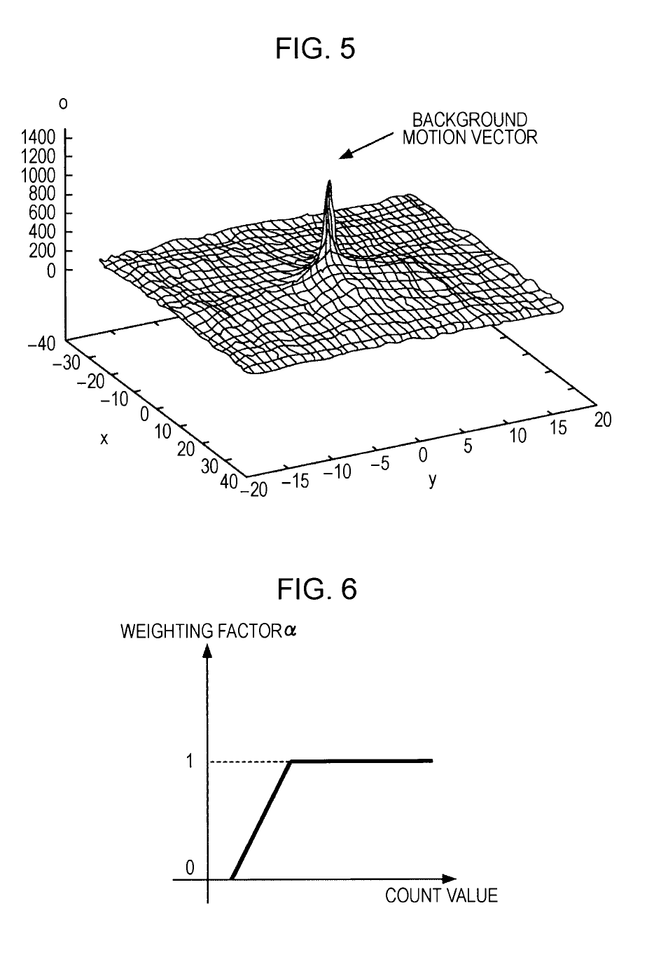

A candidate-vector extraction unit 73 generates, for example, a histogram as shown in FIG. 5 in accordance with the evaluated-value table generated by the evaluated-value table generation unit 72.

Then, the candidate-vector extraction unit 73 detects a motion vector corresponding to a peak in the histogram as a background motion vector representing the motion of a background image of the subject frame. This is because the motion vector corresponding to the peak in the histogram is regarded as being a motion vector representing the main motion in the subject frame and such motion is usually regarded as being the motion of a background image that covers most of an image of the subject frame. In the example shown in FIG. 5, the peak is positioned at the vector (0, 0). This means that the background image of the subject frame barely moves in this case.

Here, the case in which the absolute values of the differences to be related to motion vectors for corresponding pixels in the subject frame are calculated by a representative-point matching method has been described; however, for example, a block matching method, a gradient method, or the like may be used to calculate the absolute values of differences to be related to corresponding motion vectors.

Moreover, the case in which the absolute values of the differences for the motion vectors are calculated for each of the 20 representative points shown in FIG. 4 has been described; however, for example, representative points that satisfy a predetermined condition may be selected from among the 20 representative points and the absolute values of differences for motion vectors may be calculated for each of the selected representative points. For example, if a pixel serving as a representative point has low luminance and the luminance differences between the pixel and surrounding pixels are small (flat), it is desirable that data obtained from the motion vectors for the pixel serving as the representative point is not added to the histogram. This is because such motion vectors are regarded as being motion vectors having low reliability.

A background motion vector is detected in this way, and the detected background motion vector is used, for example, in motion compensation processing performed by the background image generation unit 52 as in the following.

Referring back to FIG. 2, the background image generation unit 52 generates and updates a frame of a background image (hereinafter referred to as a “background frame”).

The background image generation unit 52 stores, for example, the 0-th frame, which is the temporally earliest frame, as an initial background frame (initial data of the background frame) in a memory, which is not shown, or the like.

Moreover, the background image generation unit 52 calculates the absolute values of the differences between pixel values in a frame of input image data and corresponding pixel values in another frame existing temporally after the frame. For example, the background image generation unit 52 calculates the differences between pixel values of pixels in a first frame and pixel values of corresponding pixels in a second frame existing temporally after the first frame and determines whether the absolute value of each of the differences is less than or equal to a predetermined threshold (hereinafter referred to as a “first preset threshold”).

Here, when the background image generation unit 52 calculates the differences between the pixel values of the pixels in the second frame and the pixel values of corresponding pixels in the first frame, the background image generation unit 52 specifies the positions of the pixels in the second frame corresponding to the positions of the pixels in the first frame by performing motion compensation on the pixels in the first frame using the background motion vector detected by the background motion detection unit 51.

That is, the background image generation unit 52 performs motion compensation between two temporally adjacent frames using the background motion vector, calculates the absolute values of the differences between pixel values in the two temporally adjacent frames, and compares the absolute value of each of the differences with the first preset threshold. Here, a pixel for which the absolute value of the difference is less than or equal to the first preset threshold is regarded as being a pixel having a motion vector similar to that of a background image of the moving image. The pixel is regarded as being a pixel having a high possibility of being included in the background image. The background image generation unit 52 treats such a pixel as a candidate pixel of the background image and specifies a pixel of the background image from among one or more candidate pixels as in the following.

Thus, the background image generation unit 52 specifies the position of a pixel (candidate pixel of the background image) in the second frame, the absolute value of the difference for the pixel having been determined to be less than or equal to the first preset threshold, reads a pixel value of a pixel in the background frame, the pixel in the background frame existing at the same position as the pixel in the second frame, from the memory or the like, and calculates the absolute value of the difference between a pixel value of the pixel in the second frame and the pixel value of the pixel in the background frame. Then, the background image generation unit 52 compares the difference between the pixel value of the pixel in the second frame and the pixel value of the pixel in the background frame with a predetermined threshold (hereinafter referred to as a “second preset threshold”).

That is, the background image generation unit 52 calculates the absolute values of the differences between predetermined pixels in the latest frame (here, the second frame) and corresponding pixels in the background frame. Here, a pixel for which the absolute value of the difference is less than or equal to the second preset threshold is regarded as being a pixel of a portion that moves a little in the moving image. The pixel is regarded as being a pixel having a high possibility of being included in the background image. This is because an object existing in a moving image generally shifts (moves).

The background image generation unit 52 specifies a pixel for which the absolute value of the difference between a pixel value of the pixel in the background frame and a pixel value of a corresponding one of the predetermined pixels in the latest frame is less than or equal to the second preset threshold, from among the pixels in the background frame corresponding to the predetermined pixels in the latest frame (here, the second frame). The background image generation unit 52 then increments a counter for the pixel in the background frame by one.

Similarly, the background image generation unit 52 performs motion compensation using the background motion vector, calculates the differences between pixel values of the pixels in the second frame and pixel values of corresponding pixels in a third frame existing temporally after the second frame, and determines whether the absolute value of each of the differences is less than or equal to the first preset threshold.

Then, the background image generation unit 52 specifies the position of a pixel in the third frame, the absolute value of the difference for the pixel having been determined to be less than or equal to the first preset threshold, reads a pixel value of a pixel in the background frame, the pixel in the background frame existing at the same position as the pixel in the third frame, from the memory or the like, and compares the absolute value of the difference between a pixel value of the pixel in the third frame and the pixel value of the pixel in the background frame with the second preset threshold.

The background image generation unit 52 specifies a pixel that is included in the background frame and for which the absolute value of the difference between a pixel value of the pixel in the background frame and a pixel value of a predetermined pixel in the latest frame (here, the third frame) has been determined to be less than or equal to the second preset threshold, and increments a counter for the pixel included in the background frame by one. In contrast, the background image generation unit 52 sets, to zero, a count value of a counter for a pixel that is included in the background frame and for which the absolute value of the difference between the pixel value of the pixel in the background frame and the pixel value of a corresponding predetermined pixel in the latest frame is greater than the second preset threshold. Moreover, when the background image generation unit 52 performs motion compensation between two temporally adjacent frames using the background motion vector, the background image generation unit 52 sets, to zero, a count value of a counter for a pixel included in the background frame, the pixel existing at the position corresponding to a pixel for which the absolute value of the calculated difference is greater than the first preset threshold.

The background image generation unit 52 repeatedly executes such processing. That is, for each of the pixels in the background frame, if the pixel in the background frame has been determined to be a pixel of a background image a plurality of times in succession, the number of times the pixel in the background frame has been determined to be a pixel of the background image is stored as the counter for the pixel.

Moreover, when the background image generation unit 52 increments such a counter, the background image generation unit 52 determines whether a count value of the counter is already greater than or equal to a preset threshold (hereinafter referred to as a “third preset threshold”). If the background image generation unit 52 determines that the count value of the counter is greater than or equal to the third preset threshold, the background image generation unit 52 calculates a pixel value of a pixel corresponding to the counter and included in the background frame. Here, a pixel whose count value has been determined to be greater than or equal to the third preset threshold is a pixel that has been determined to be a pixel of the background image a plurality of times in succession. Thus, the pixel can be regarded as being a pixel having high continuity with respect to the background image.

The background image generation unit 52 calculates a value X of a pixel included in the background frame using, for example, the following expression.

X=αY+(1−α)Z

Here, Y represents a pixel value of a pixel in the latest frame and Z represents a pixel value of a pixel in the background frame, the background frame being stored in the memory or the like. Moreover, α represents a weighting factor and is determined in accordance with the count value for the pixel in the background frame.

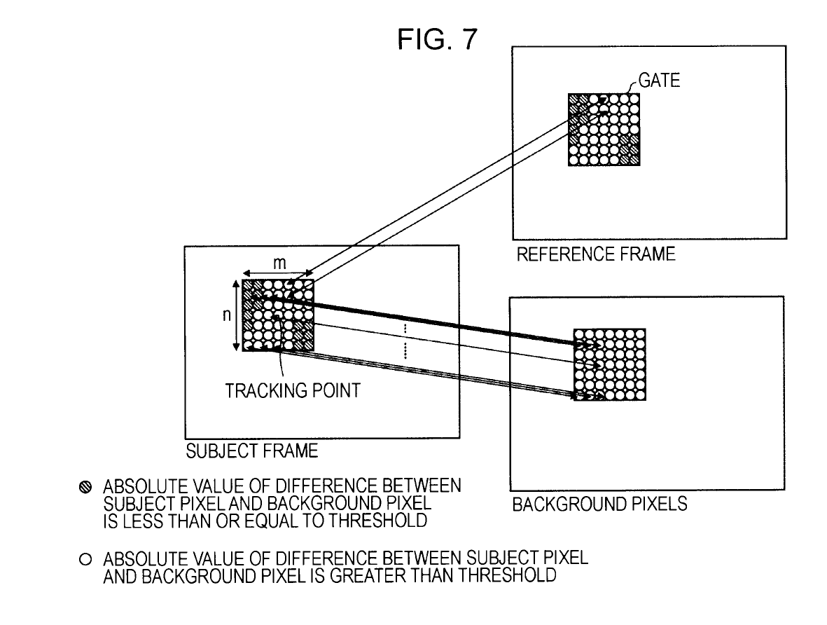

FIG. 6 is a graph of the value of the weighting factor a versus the count value. As shown in FIG. 6, the value of the weighting factor α is in the range of from zero to one. The value of the weighting factor α is set to approach one as the count value becomes larger, and set to remain at a value of one on every occasion after the count value exceeds a predetermined value. Here, the background image generation unit 52 prestores data regarding a graph as shown in FIG. 6.

That is, a pixel value of a pixel having high continuity (large count value) and included in the background frame is updated to a value close to a pixel value of a corresponding pixel included in the latest frame. A pixel value of a pixel having higher continuity and included in the background frame is replaced with a pixel value of a corresponding pixel included in the latest frame. In this way, the background image generation unit 52 updates a pixel value of a pixel included in the background frame using the above-described expression, the pixel having been determined to have high continuity with respect to a background image.

The background image generation unit 52 generates and updates the image of the background frame in this way.

Referring back to FIG. 2, the gate generation unit 53 generates a gate, which is an area where motion detection is performed by the tracking-point motion detection unit 54.

The gate generation unit 53 calculates the absolute values of the differences between pixel values of pixels in the subject frame and pixel values of corresponding pixels in the background frame generated by the background image generation unit 52, and sets an area called a gate by determining whether the absolute value of each of the differences is less than or equal to a preset threshold (hereinafter referred to as a “fourth preset threshold”).

The gate generation unit 53 treats, as the subject frame, a frame in which, for example, a tracking point has already been specified as shown in FIG. 7 and sets a motion detection area constituted by a predetermined number of pixels having the tracking point as the center.

In the example shown in FIG. 7, a motion detection area constituted by (n×m) pixels having the pixel existing at the tracking point for the subject frame as the center.

The gate generation unit 53 obtains pixels included in a motion detection area of the background frame corresponding to the motion detection area of the subject frame. Here, the gate generation unit 53 obtains pixels, each of which exists at the same position as a corresponding one of the pixels included in the motion detection area set in the subject frame, from the background frame generated by the background image generation unit 52 and stored in the memory or the like.

Then, the gate generation unit 53 calculates the absolute values of the differences between pixel values of the pixels in the motion detection area of the subject frame and pixel values of corresponding pixels in the motion detection area of the background frame. Here, a pixel for which the absolute value of the difference is less than or equal to the fourth preset threshold is regarded as being a pixel of a background image, and a pixel for which the absolute values of the difference is greater than the fourth preset threshold is regarded as being a pixel of an image of an object that is desired to be tracked.

The gate generation unit 53 specifies pixels for which the absolute values of the differences are greater than the fourth preset threshold, from among the pixels in the motion detection area of the subject frame, and, for example, specifies the coordinates of the pixels as the coordinates of a gate.

The gate generation unit 53 sets, in accordance with the specified coordinates as described above, a gate in the reference frame in which a tracking point is to be detected and that exists temporally after the subject frame. As a result, for example, a gate is set in the reference frame as shown in FIG. 7.

Referring back to FIG. 2, the tracking-point motion detection unit 54 detects the motion of the tracking point for the subject frame using pixels included in the gate generated by the gate generation unit 53.

For example, the tracking-point motion detection unit 54 detects the motion of the tracking point for the subject frame by determining which pixel in the reference frame the tracking point for the subject frame shown in FIG. 7 corresponds to. Here, the tracking-point motion detection unit 54 detects a motion vector for the pixel existing at the tracking point for the subject frame by performing processing such as block matching, representative-point matching, or the like using only pixels included in the gate, the pixels being selected as described above with reference to FIG. 7.

The tracking-point determination unit 55 specifies which position in the reference frame the tracking point for the subject frame moves to, in accordance with the motion vector detected by the tracking-point motion detection unit 54, and determines the pixel existing at the specified position as the pixel existing at a tracking point for the reference frame.

In this way, for each of the frames of a moving image, a tracking point for the frame is detected. According to an embodiment of the present invention, the motion of a tracking point is detected using only pixels included in a gate set by the gate generation unit 53, and thus an object image can be tracked more efficiently and with more certainty.

In an existing technology, pixels of an object image and pixels of a background image may be included in a gate. In such a case, a wrong tracking point may be detected if the object image is tracked in accordance with only the pixels included in the gate.

According to an embodiment of the present invention, the gate generation unit 53 generates a gate by eliminating pixels of a background image from among pixels included in the motion detection area corresponding to an existing gate based on an existing technology. Thus, an object image can be tracked with high certainty in accordance with only pixels included in the gate.

Moreover, in the existing technology, for example, if an object image and a background image move similarly, a wrong tracking point may be detected.

According to an embodiment of the present invention, any pixel regarded as being a pixel of a background image is eliminated from among pixels included in a motion detection area in accordance with a pixel value of a corresponding pixel included in the background frame generated by the background image generation unit 52. Thus, for example, even if an object image and a background image move similarly, only pixels regarded as being pixels of the background image can be eliminated with certainty from among the pixels included in the motion detection area.

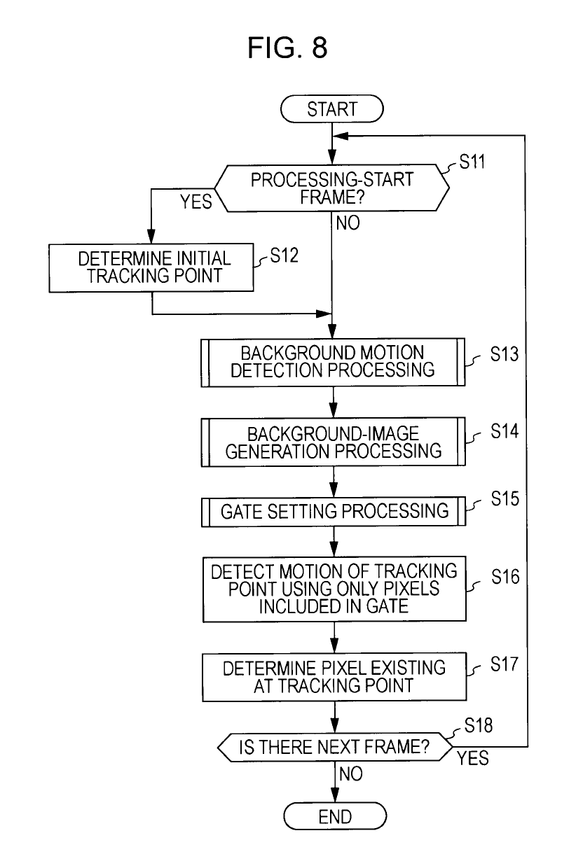

Next, with reference to a flowchart shown in FIG. 8, object tracking processing performed by the object tracking system 10 according to an embodiment of the present invention will be described. This processing is executed when, for example, image data of a moving image to be processed for tracking an object image is input.

In step S11, the tracking unit 24 determines whether input image data is data of a frame from which processing starts (hereinafter referred to as a “processing-start frame”). In step S11, if the tracking unit 24 determines that the input image data is the data of the processing-start frame, the procedure proceeds to step S12. If the tracking unit 24 determines that the input image data is not the data of the processing-start frame, the procedure proceeds to step S13.

In step S12, the tracking unit 24 determines an initial tracking point. The initial tracking point is, for example, determined by specifying the coordinates of a pixel corresponding to a position specified as a tracking point by a user in an image displayed on the image display 26.

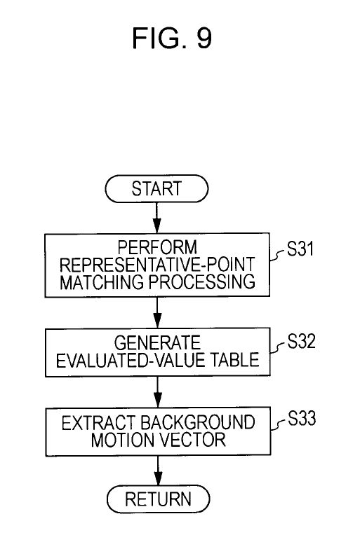

In step S13, the background motion detection unit 51 executes background motion detection processing, which will be described below with reference to FIG. 9. As a result, a background motion vector is detected.

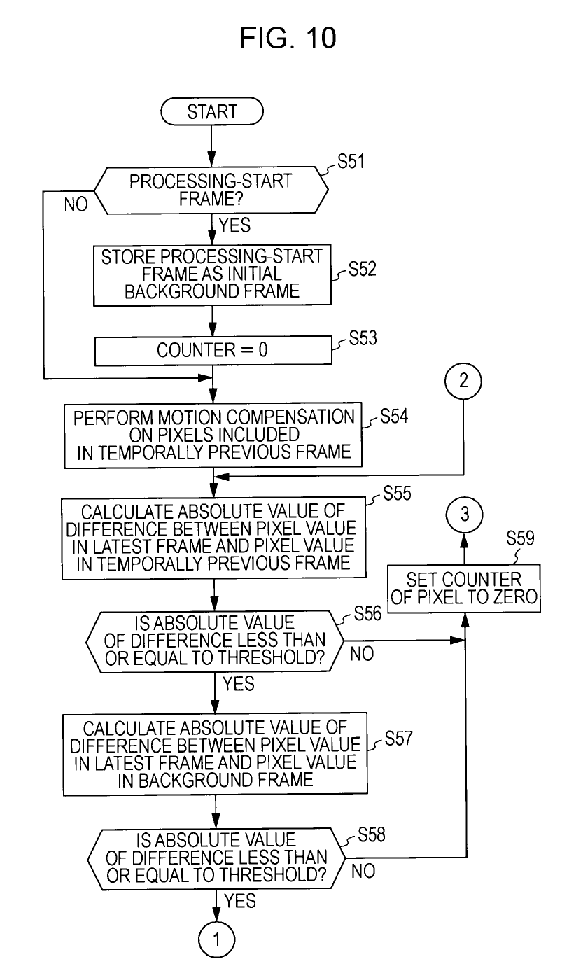

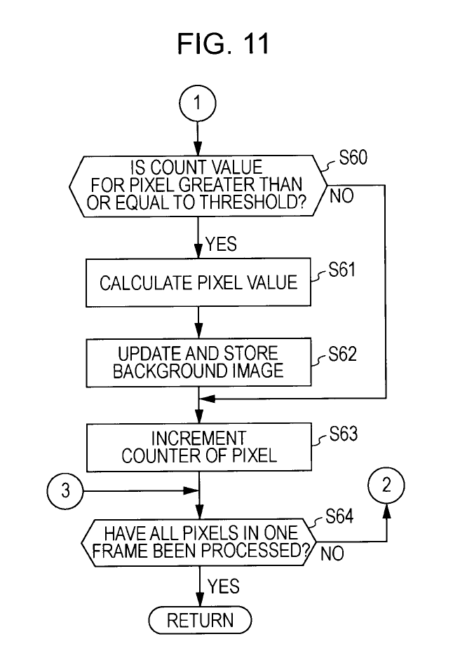

In step S14, the background image generation unit 52 executes background-image generation processing, which will be described below with reference to FIGS. 10 and 11. As a result, a background frame is generated.

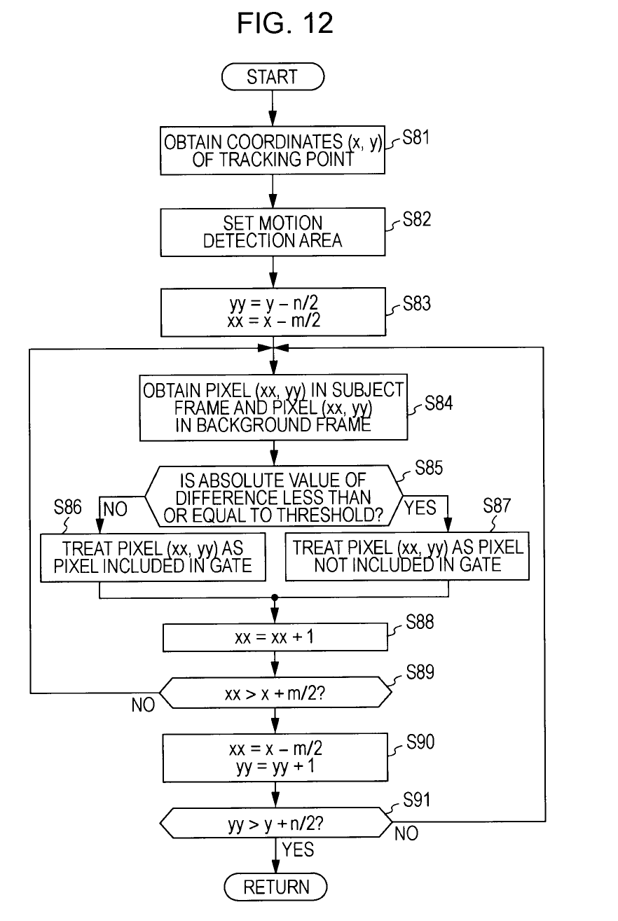

In step S15, the gate generation unit 53 executes gate setting processing, which will be described below with reference to FIG. 12. As a result, a gate is set.

In step S16, the tracking-point motion detection unit 54 performs block matching, representative-point matching, or the like using only pixels included in the gate set by processing in step S15, and detects a motion vector for the pixel existing at the tracking point.

In step S17, the tracking-point determination unit 55 specifies which position in the reference frame the tracking point for the subject frame moves to in accordance with the motion vector detected by processing in step S16, and determines a pixel existing at the specified position as the pixel existing at the tracking point for the reference frame.

In step S18, the tracking unit 24 determines whether the next frame exists. If the tracking unit 24 determines that the next frame exists, the procedure returns to step S11 and processing in and after step S11 is executed again. In step S18, if the tracking unit 24 determines that no next frame exists, the procedure ends.

Next, background motion detection processing in step S13 of FIG. 8 will be more specifically described with reference to a flowchart shown in FIG. 9.

In step S31, the representative-point matching processing unit 71 performs representative-point matching processing.

Here, for example, as described above with reference to FIG. 4, the representative-point matching processing unit 71 sets, for example, a predetermined representative point in the subject frame. Then, the representative-point matching processing unit 71 calculates the absolute values of the differences between a pixel value of a pixel serving as the predetermined representative point in the subject frame and pixel values of pixels included in a search area of the reference frame. The representative-point matching processing unit 71 stores the absolute values of the differences in relation to corresponding motion vectors. In this way, the representative-point matching processing unit 71 performs processing for calculating the absolute values of the differences and storing the absolute values of the differences in relation to corresponding motion vectors, for each of representative pixels (for example, 20 representative pixels) in the subject frame.

In step S32, the evaluated-value table generation unit 72 generates an evaluated-value table for motion vectors in accordance with a processing result in step S31.

Here, the evaluated-value table generation unit 72 compares, for example, the absolute value of each of the differences calculated by the representative-point matching processing unit 71 with the preset threshold. If the absolute value of the difference is less than or equal to the preset threshold, the evaluated-value table generation unit 72 increments, by one, the evaluated value of the motion vector related to the absolute value of the difference. The evaluated-value table generation unit 72 generates an evaluated-value table for motion vectors by performing such processing on all the absolute values of the differences calculated by the representative-point matching processing unit 71.

In step S33, the candidate-vector extraction unit 73 generates a histogram in accordance with the evaluated-value table generated by processing in step S32, and extracts a background motion vector.

Here, the candidate-vector extraction unit 73 generates, for example, the histogram as shown in FIG. 5. Then, the candidate-vector extraction unit 73 extracts the motion vector corresponding to the peak in the histogram as the background motion vector representing the motion of the background image of the subject frame.

In this way, a background motion vector is detected.

Here, the case in which the absolute values of the differences related to the motion vectors for the pixels included in the subject frame are calculated by a representative-point matching method has been described; however, for example, a block matching method, a gradient method, or the like may be used to calculate the absolute values of differences related to the motion vectors.

Moreover, for example, the case in which the absolute values of the differences for the motion vectors are calculated for each of the 20 representative points shown in FIG. 4 has been described; however, for example, representative points that satisfy a predetermined condition may be selected from among the 20 representative points and the absolute values of differences for motion vectors may be calculated for each of the selected representative points. For example, if a pixel serving as a representative point has low luminance and the luminance differences between the pixel and surrounding pixels are small (flat), it is desirable that data obtained from the motion vectors for the pixel serving as the representative point is not added to the histogram.

Next, background-image generation processing in step S14 of FIG. 8 will be more specifically described with reference to flowcharts shown in FIGS. 10 and 11.

In step S51, the background image generation unit 52 determines whether the frame currently input is the processing-start frame. For example, if the first (temporally first) frame among the frames constituting data of a moving image is input, the background image generation unit 52 determines, in step S51, that the input frame is the processing-start frame. Then, the procedure proceeds to step S52.

In step S52, the background image generation unit 52 stores the processing-start frame as the initial background frame (initial data of the background frame) in the memory, not shown, or the like.

After performance of processing in step S52, in step S53, the background image generation unit 52 sets all count values of counters to zero, each of the counters being assigned to a corresponding one of pixels constituting an image of one frame.

In a case where the background image generation unit 52 determines, in step S51, that the frame currently input is not the processing-start frame or after performance of processing in step S53, the procedure proceeds to step S54 and the background image generation unit 52 performs motion compensation on pixels included in a temporally previous frame in accordance with the background motion vector detected by processing in step S13.

Here, the temporally previous frame is, for example, a frame stored in a memory or the like provided to delay image data for a time during which one frame is displayed.

In step S54, for example, the positions of pixels included in the frame currently input (the latest frame) corresponding to the positions of the pixels included in the temporally previous frame are specified by performing motion compensation on the pixels included in the temporally previous frame.

In step S55, the background image generation unit 52 calculates the absolute value of the difference between a pixel value of a pixel included in the latest frame and a pixel value of a corresponding pixel included in the temporally previous frame.

Here, such calculation in step S55 for obtaining the absolute value of the difference is performed between the pixel values of the pixels in the latest frame and the pixel values of corresponding pixels in the temporally previous frame. In this case, for example, the absolute value of the difference between the pixel value of the pixel existing at the coordinates (x, y) in the latest frame and the pixel value of the pixel existing at the coordinates (x, y) in the temporally previous frame is calculated. Then, when processing in step S55 is executed again, the absolute value of the difference between the pixel value of the pixel existing at the coordinates (x+1, y) in the latest frame and the pixel value of the pixel existing at the coordinates (x+1, y) in the temporally previous frame is executed and so on. In this way, the absolute values of the differences are obtained between the pixel values of the pixels in the latest frame and the pixel values of corresponding pixels in the temporally previous frame.

In step S56, the background image generation unit 52 determines whether the absolute value of the difference calculated by processing in step S55 is less than or equal to the first preset threshold.

In step S56, if the background image generation unit 52 determines that the absolute value of the difference calculated by processing in step S55 is less than or equal to the first preset threshold, the procedure proceeds to step S57.

In step S57, the background image generation unit 52 specifies the position of a pixel for which the absolute value of the difference has been determined to be less than or equal to the first preset threshold by processing in step S56, reads a pixel value of a pixel included in the background frame and existing at the same position as the pixel for which the absolute value of the difference has been determined to be less than or equal to the first preset threshold, from the memory or the like, and calculates the absolute value of the difference between a pixel value of the pixel included in the latest frame and a pixel value of the pixel included in the background frame.

In step S58, the background image generation unit 52 determines whether the absolute value of the difference calculated by processing in step S57 is less than or equal to the second preset threshold.

In step S58, if the background image generation unit 52 determines that the absolute value of the difference calculated by processing in step S57 is not less than or equal to the second preset threshold, the procedure proceeds to step S59. Moreover, in step S56, if the background image generation unit 52 determines that the absolute value of the difference calculated by processing in step S55 is not less than or equal to the first preset threshold, the procedure also proceeds to step S59.

In step S59, the background image generation unit 52 sets, to zero, a count value of a counter for the pixel included in the background frame. After performance of processing in step S59, the procedure proceeds to step S64 of FIG. 11.

In contrast, in step S58, if the background image generation unit 52 determines that the absolute value of the difference calculated by processing in step S57 is less than or equal to the second preset threshold, the procedure proceeds to step S60 of FIG. 11.

In step S60, the background image generation unit 52 determines whether the count value for the pixel is greater than or equal to the third preset threshold. If the background image generation unit 52 determines that the count value for the pixel is greater than or equal to the third preset threshold, the procedure proceeds to step S61.

In step S61, the background image generation unit 52 calculates a pixel value of the pixel included in the background image. Then, as described above, for example, the value X of the pixel included in the background frame is calculated using the following expression.

X=αY+(1−α)Z

Here, Y represents a pixel value of a pixel included in the latest frame and Z represents a pixel value of a pixel included in the background frame stored in a memory or the like. Moreover, α represents a weighting factor and is determined in accordance with the count value for the pixel in the background frame, as described above, using the data as shown in FIG. 6.

In step S62, the background image generation unit 52 replaces the pixel value of the pixel included in the background image with the value calculated by processing in step S61, and updates data of the background frame.

In step S63, the background image generation unit 52 increments the count value for the pixel by one. Here, the value of the weighting factor α may be stored in relation to the count value.

In step S64, the background image generation unit 52 determines whether processing has been finished for all pixels in one frame. If the background image generation unit 52 determines that processing has not been finished for all pixels in one frame, the procedure returns to step S55 and processing in and after step S55 is executed again.

In step S64, if the background image generation unit 52 determines that processing has been finished for all pixels in one frame, background-image generation processing ends and the procedure proceeds to step S15 of FIG. 8.

In this way, background-image generation processing is executed. In this way, a pixel value of a pixel included in the background frame and having high continuity (large count value) is updated to a value close to a pixel value of a corresponding pixel included in the latest frame. A pixel value of a pixel having higher continuity is replaced with a pixel value of a corresponding pixel included in the latest frame. As a result, the background image appropriate for processing that is performed on the latest frame can be generated and stored.

Next, gate setting processing in step S15 of FIG. 8 will be more specifically described with reference to a flowchart shown in FIG. 12.

In step S81, the gate generation unit 53 obtains the coordinates (x, y) of the tracking point determined by processing in step S12 or S17.

In step S82, the gate generation unit 53 sets a motion detection area. Here, for example, a motion detection area constituted by a predetermined number of pixels having the tracking point as the center is set as described above with reference to FIG. 7. For example, a motion detection area constituted by m pixels horizontally and n pixels vertically having the tracking point as the center is set.

In step S83, the value of a variable xx used as a coordinate value representing the horizontal position of a pixel is set to (x−m/2), and the value of a variable yy used as a coordinate value representing the vertical position of the pixel is set to (y−n/2).

In step S84, the gate generation unit 53 obtains a pixel (xx, yy) in the subject frame and a pixel (xx, yy) in the background frame. Here, for example, the subject frame is, for example, a frame one frame previous to the latest frame and the background frame is generated by the background image generation unit 52 in processing performed in step S14 and stored in the memory or the like.

In step S85, the gate generation unit 53 determines whether the absolute value of the difference between a pixel value of the pixel (xx, yy) in the subject frame and a pixel value of the pixel (xx, yy) in the background frame is less than or equal to the fourth preset threshold.

In step S85, if the gate generation unit 53 determines that the absolute value of the difference between the pixel value of the pixel (xx, yy) in the subject frame and the pixel value of the pixel (xx, yy) in the background frame is greater than the fourth preset threshold, the procedure proceeds to step S86. The gate generation unit 53 treats the pixel (xx, yy) as a pixel included in a gate.

In contrast, in step S85, if the gate generation unit 53 determines that the absolute value of the difference between the pixel value of the pixel (xx, yy) in the subject frame and the pixel value of the pixel (xx, yy) in the background frame is less than or equal to the fourth preset threshold, the procedure proceeds to step S87. The gate generation unit 53 treats the pixel (xx, yy) as a pixel not included in the gate.

After performance of processing in step S86 or S87, the gate generation unit 53 increments the value of the variable xx by one in step S88.

In step S89, the gate generation unit 53 determines whether the value of the variable xx has exceeded x+m/2. In step S89, if the gate generation unit 53 determines that the value of the variable xx has not exceeded x+m/2, the procedure returns to step S84 and processing in and after step S84 is executed again.

In step S89, if the gate generation unit 53 determines that the value of the variable xx has exceeded x+m/2, the procedure proceeds to step S90.

In step S90, the gate generation unit 53 sets the value of the variable xx to (x−m/2) and increments the value of the variable yy by one.

In step S91, the gate generation unit 53 determines whether the value of the variable yy has exceeded y+n/2. In step S91, if the gate generation unit 53 determines that the value of the variable yy has not exceeded y+n/2, the procedure returns to step S84 and processing in and after step S84 is executed again.

In step S91, if the gate generation unit 53 determines that the value of the variable yy has exceeded y+n/2, this means that every pixel included in the motion detection area has been determined whether the pixel is a pixel included in the gate or a pixel not included in the gate. Thus, gate setting processing ends and the procedure proceeds to step S16 of FIG. 8.

In this way, a gate is set. By setting such a gate, a pixel of a background image can be eliminated from a motion detection area regarding a tracking point. As a result, the motion of the tracking point can be detected efficiently and with certainty.

In this way, a gate is generated by eliminating any pixel regarded as being a pixel of a background image from among pixels included in a motion detection area corresponding to an existing gate based on an existing technology, and thus an object image can be tracked efficiently and with high certainty in accordance with only pixels included in the gate in object tracking processing performed by the object tracking system 10 according to an embodiment of the present invention.

Moreover, a background frame is generated, and any pixel regarded as being a pixel of a background image is eliminated from among pixels included in a motion detection area in accordance with pixel values of pixels included in the background frame in object tracking processing performed by the object tracking system 10 according to an embodiment of the present invention. Thus, for example, even if an object image and a background image move similarly, only pixels regarded as being pixels of the background image can be eliminated with certainty from among the pixels included in the motion detection area.

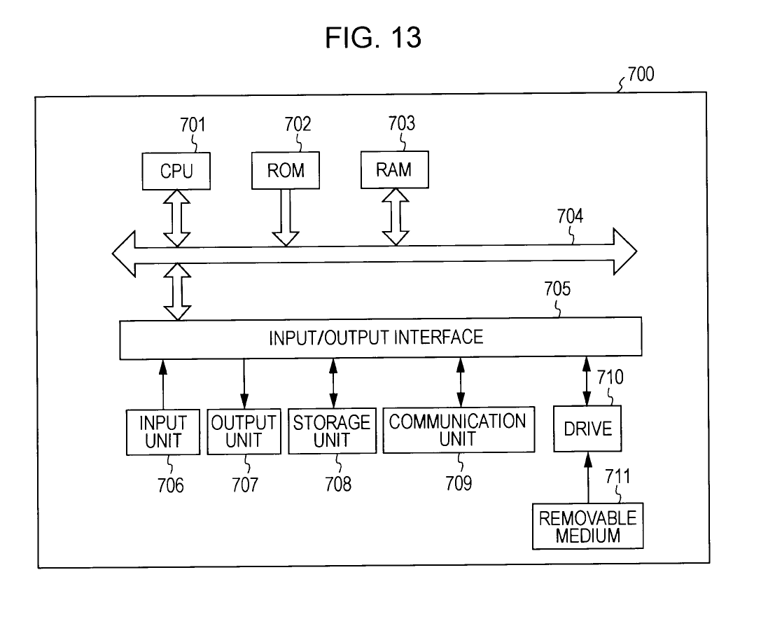

Here, the above-described series of processing operations may be executed by hardware or by software. If the above-described series of processing operations are executed by software, a program constituting the software is installed onto a computer built in dedicated hardware or, for example, a general-purpose computer 700 as shown in FIG. 13, the general-purpose computer 700 being capable of executing various functions by installing various programs thereon or the like via a network or a recording medium.

In FIG. 13, a central processing unit (CPU) 701 executes various processing operations in accordance with a program stored in a read-only memory (ROM) 702 or a program loaded into a random access memory (RAM) 703 from a storage unit 708. The data necessary for the CPU 701 to execute the various processing operations is stored in the RAM 703 as necessary.

The CPU 701, the ROM 702, and the RAM 703 are connected to each other via a bus 704. Moreover, an input/output interface 705 is connected to the bus 704.

An input unit 706, an output unit 707, a storage unit 708, and a communication unit 709 are connected to the input/output interface 705. The input unit 706 includes a keyboard, a mouse, and the like. The output unit 707 includes a display, such as a cathode-ray tube (CRT) or a liquid crystal display (LCD), a speaker, and the like. The storage unit 708 includes a hard disk and the like. The communication unit 709 includes a modem, a network interface card such as a LAN card, and the like. The communication unit 709 performs communication processing via a network including the Internet.

Moreover, a drive 710 is connected to the input/output interface 705 as necessary. A removable medium 711 such as a magnetic disk, an optical disc, a magneto-optical disk, or a semiconductor memory is loaded into the input/output interface 705 as necessary. A computer program read from the removable medium 711 is installed onto the storage unit 708 as necessary.

If the above-described series of processing operations are executed by software, a program constituting the software is installed via a network such as the Internet or from a recording medium such as the removable medium 711.

Here, this recording medium includes the removable medium 711, shown in FIG. 13, such as a magnetic disk (such as a floppy disk), an optical disc (such as a compact disc-read-only memory (CD-ROM) or a digital versatile disc (DVD)), a magneto-optical disk (such as a MiniDisc (MD)), or a semiconductor memory, a program being recorded on the removable medium 711, which is provided in addition to an apparatus, and the program being distributed to a user via the removable medium 711. The recording medium also includes the ROM 702, a hard disk included in the storage unit 708, and the like, a program being recorded on the ROM 702 or the hard disk and the program being distributed to a user in a state in which the program being prestored in the ROM 702 or the hard disk, respectively.

Here, steps of executing the above-described series of processing operations in this specification may be executed in time series in the order described above, and may not be executed in time series on every occasion. The steps of executing the above-described series of processing operations in this specification may be executed in parallel or individually.

The present application contains subject matter related to that disclosed in Japanese Priority Patent Application JP 2008-167296 filed in the Japan Patent Office on Jun. 26, 2008, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A tracking-point detection apparatus, comprising:
background motion vector detection means for detecting motion vectors for pixels in a frame from among frames constituting a moving image and detecting, in accordance with the detected motion vectors, a background motion vector representing the motion of a background image of the moving image;
background image generation means for calculating and updating a pixel value of a pixel in a background frame, which is a frame of a background image, stored in a memory by performing motion compensation on a pixel in the frame in accordance with the detected background motion vector;
gate setting means for setting an area in which detection of a motion vector representing the motion of a pixel existing at a tracking point specified in the frame is performed as a motion detection area constituted by a predetermined number of pixels having the pixel existing at the tracking point as the center, and setting a gate constituted by pixels, the number of which being less than or equal to the number of the pixels included in the motion detection area, by eliminating a pixel regarded as being a pixel of the background image of the moving image from the pixels included in the motion detection area in accordance with data of the background frame stored in the memory;
tracking-point motion detection means for detecting a motion vector for the pixel existing at the tracking point using a pixel included in the gate; and
tracking-point determination means for determining a pixel existing at a tracking point for the latest frame in accordance with the detected motion vector for the pixel existing at the tracking point for the frame.

2. The tracking-point detection apparatus according to claim 1,
wherein the background-image generation means stores, in the memory, data of a frame from which processing starts as initial data of the background frame,
performs motion compensation on each of pixels in a temporally previous frame that is temporally previous to the latest frame in accordance with the background motion vector, and
detects a candidate for a pixel of the background image of the moving image by determining whether the absolute value of the difference between a pixel value of a pixel in the latest frame and a pixel value of a corresponding pixel in the temporally previous frame is less than or equal to a first preset threshold.

3. The tracking-point detection apparatus according to claim 2,
wherein, in a case where the absolute value of the difference between the pixel value of the pixel in the latest frame and the pixel value of the corresponding pixel in the temporally previous frame is determined to be less than or equal to the first preset threshold, the background-image generation means further calculates the absolute value of the difference between the pixel value of the pixel in the latest frame and a pixel value of a corresponding pixel in the background frame,
increments a count value of a counter for the corresponding pixel in the background frame if the absolute value of the difference between the pixel value of the pixel in the latest frame and the pixel value of the corresponding pixel in the background frame is determined to be less than or equal to a second preset threshold, and
determines whether the pixel value of the corresponding pixel in the background frame should be updated in accordance with the count value of the counter for the corresponding pixel in the background frame.

4. The tracking-point detection apparatus according to claim 3,
wherein, in a case where the absolute value of the difference between the pixel value of the pixel in the latest frame and the pixel value of the corresponding pixel in the temporally previous frame is determined to be less than or equal to the first preset threshold and the absolute value of the difference between the pixel value of the pixel in the latest frame and the pixel value of the corresponding pixel in the background frame is determined to be less than or equal to the second preset threshold, the background-image generation means determines whether the count value of the counter for the corresponding pixel in the background frame is greater than or equal to a third preset threshold, and
calculates a pixel value of the corresponding pixel in the background frame by performing predetermined calculation if the count value of the counter for the corresponding pixel in the background frame is determined to be greater than or equal to the third preset threshold.

5. The tracking-point detection apparatus according to claim 4,
wherein the background-image generation means calculates a pixel value of the corresponding pixel in the background frame using the pixel value of the pixel in the latest frame, the pixel value of the corresponding pixel in the background frame, and a weighting factor determined in accordance with the count value of the counter for the corresponding pixel in the background frame.

6. The tracking-point detection apparatus according to claim 1,
wherein the gate setting means sets, in the temporally previous frame, a motion detection area constituted by a predetermined number of pixels having a pixel existing at a tracking point as the center, the tracking point being specified in a temporally previous frame that is temporally previous to the latest frame,
reads pixels in the background frame from the memory, the pixels corresponding to the motion detection area, and
sets the gate by eliminating a pixel regarded as being a pixel of the background image of the moving image from among the pixels included in the motion detection area, the pixel regarded as being a pixel of the background image of the moving image being a pixel in the temporally previous frame and being a pixel for which the absolute value of the difference between a pixel value of the pixel in the temporally previous frame and a pixel value of a corresponding pixel in the background frame is less than or equal to a preset threshold.

7. The tracking-point detection apparatus according to claim 1,
wherein the background motion vector detection means detects motion vectors for the pixels in the frame, each of the motion vectors being detected in accordance with the absolute value of the difference between a pixel value of a corresponding pixel in the latest frame and a pixel value of a corresponding pixel in a temporally previous frame that is temporally previous to the latest frame,
generates a histogram regarding the detected motion vectors, and
detects a motion vector indicated by a peak in the generated histogram as the background motion vector.

8. A tracking-point detection method, comprising the steps of:
detecting motion vectors for pixels in a frame from among frames constituting a moving image and detecting, in accordance with the detected motion vectors, a background motion vector representing the motion of a background image of the moving image;
calculating and updating a pixel value of a pixel in a background frame, which is a frame of a background image, stored in a memory by performing motion compensation on a pixel in the frame in accordance with the detected background motion vector;
setting an area in which detection of a motion vector representing the motion of a pixel existing at a tracking point specified in the frame is performed as a motion detection area constituted by a predetermined number of pixels having the pixel existing at the tracking point as the center, and setting a gate constituted by pixels, the number of which being less than or equal to the number of the pixels included in the motion detection area, by eliminating a pixel regarded as being a pixel of the background image of the moving image from the pixels included in the motion detection area in accordance with data of the background frame stored in the memory;
detecting a motion vector for the pixel existing at the tracking point using a pixel included in the gate; and
determining a pixel existing at a tracking point for the latest frame in accordance with the detected motion vector for the pixel existing at the tracking point for the frame.

9. A program for causing a computer to function as:
background motion vector detection means for detecting motion vectors for pixels in a frame from among frames constituting a moving image and detecting, in accordance with the detected motion vectors, a background motion vector representing the motion of a background image of the moving image;
background image generation means for calculating and updating a pixel value of a pixel in a background frame, which is a frame of a background image, stored in a memory by performing motion compensation on a pixel in the frame in accordance with the detected background motion vector;
gate setting means for setting an area in which detection of a motion vector representing the motion of a pixel existing at a tracking point specified in the frame is performed as a motion detection area constituted by a predetermined number of pixels having the pixel existing at the tracking point as the center, and setting a gate constituted by pixels, the number of which being less than or equal to the number of the pixels included in the motion detection area, by eliminating a pixel regarded as being a pixel of the background image of the moving image from the pixels included in the motion detection area in accordance with data of the background frame stored in the memory;
tracking-point motion detection means for detecting a motion vector for the pixel existing at the tracking point using a pixel included in the gate; and
tracking-point determination means for determining a pixel existing at a tracking point for the latest frame in accordance with the detected motion vector for the pixel existing at the tracking point for the frame.

10. A recording medium having a program according to claim 9 thereon.

11. A tracking-point detection apparatus, comprising:
a background motion vector detection unit configured to detect motion vectors for pixels in a frame from among frames constituting a moving image and to detect, in accordance with the detected motion vectors, a background motion vector representing the motion of a background image of the moving image;
a background image generation unit configured to calculate and update a pixel value of a pixel in a background frame, which is a frame of a background image, stored in a memory by performing motion compensation on a pixel in the frame in accordance with the detected background motion vector;
a gate setting unit configured to set an area in which detection of a motion vector representing the motion of a pixel existing at a tracking point specified in the frame is performed as a motion detection area constituted by a predetermined number of pixels having the pixel existing at the tracking point as the center, and to set a gate constituted by pixels, the number of which being less than or equal to the number of the pixels included in the motion detection area, by eliminating a pixel regarded as being a pixel of the background image of the moving image from the pixels included in the motion detection area in accordance with data of the background frame stored in the memory;
a tracking-point motion detection unit configured to detect a motion vector for the pixel existing at the tracking point using a pixel included in the gate; and
a tracking-point determination unit configured to determine a pixel existing at a tracking point for the latest frame in accordance with the detected motion vector for the pixel existing at the tracking point for the frame.
